(19) United States
(12) Patent Application Publication
(10) Pub. No.: US 2019/0176157 A1
(43) Pub. Date: Jun. 13, 2019

(54) MEASUREMENT APPARATUS AND SAMPLE HOLDER USED IN THE SAME

(71) Applicant: Otsuka Electronics Co., Ltd., Osaka (JP)

(72) Inventor: Hisashi SHIRAIWA, Koka-shi (JP)

(73) Assignee: Otsuka Electronics Co., Ltd., Osaka (JP)

(21) Appl. No.: 16/199,018

(22) Filed: Nov. 23, 2018

(30) Foreign Application Priority Data
Dec. 13, 2017 (JP) 2017-238759

(51) Int. Cl. B01L 9/00; G01J 3/02; G02B 21/34

(52) U.S. Cl. CPC B01L 9/523; G02B 21/34; G01J 3/0267

(57) ABSTRACT

A measurement apparatus includes: a sample holder on which a plurality of samples can be placed; a measurement unit configured to measure the plurality of samples placed on the sample holder; and a control unit configured to control a position of the measurement unit relative to a sample to be measured. The sample holder includes a substrate, and a holding unit configured to hold the sample. The substrate is provided with a plurality of holding units. The holding unit is configured to hold each of a plurality of samples having different shapes at a center position of the holding unit.

### BACKGROUND OF THE INVENTION

### Field of the Invention

The present technique relates to a measurement apparatus configured to measure a sample held by a sample holder and the sample holder used in the measurement apparatus.

### Description of the Background Art

For conducting an X-ray analysis or a measurement/an inspection by an optical system, a sample held by a sample holder for a measurement apparatus is measured and inspected. There are proposals of sample holders each configured to be capable of holding samples having various shapes. For example, Japanese Patent Laying-Open No. 2010-249760 proposes a sample holder including a circular block-shaped member provided with a holding recess portion formed in a V-shaped groove so as to be capable of reliably and stably holding a columnar sample, a cylindrical sample and a spherical sample.

Furthermore, Japanese Patent Laying-Open No. 2001-289753 proposes a sample holder including a substrate provided with an aperture changing mechanism, a sample holding mechanism and the like, in which the aperture changing mechanism is caused to pivot such that variously-sized samples can be moved to the measurement center position.

### SUMMARY OF THE INVENTION

The sample holder disclosed in PTD 1 can hold only one sample. Accordingly, in order to measure one sample and thereafter measure another sample, it is necessary to perform the operation of exchanging the held sample. Specifically, when a sample is measured using the sample holder disclosed in PTD 1, it is necessary to repeatedly perform the operation of holding one sample with the sample holder and measuring the held sample, then removing the sample from the sample holder after the measurement, and then, again holding another sample with the sample holder and measuring the held another sample.

Furthermore, the sample holder disclosed in PTD 1 requires a sample to be held in a holding recess portion formed in a V-shaped groove, which requires the sample to be held at any one position in the direction along the V-shaped groove. Accordingly, depending on the size of the sample, it is necessary to perform the operation of determining the position of the sample such that the sample is held at the center position of the sample holder.

Furthermore, the sample holder disclosed in PTD 2 requires the operation of adjusting the aperture changing mechanism according to the size of the sample to be held by the sample holding mechanism. Also, the sample holder disclosed in PTD 2 requires the operation of, each time a sample having a different shape is held, adjusting the aperture changing mechanism such that the sample is located at the measurement center position.

The present technique aims to provide: a sample holder that can reduce the operations of holding and removing a sample during measurement of a plurality of samples to thereby facilitate alignment of the held sample; and a measurement apparatus configured to use the sample holder.

A measurement apparatus according to an aspect of the present invention is configured to measure a sample. The measurement apparatus includes: a sample holder on which a plurality of samples can be placed; a measurement unit configured to measure the plurality of samples placed on the sample holder; and a control unit configured to control a position of the measurement unit relative to a sample to be measured. The sample holder includes a substrate, and a holding unit configured to hold a sample. The substrate is provided with a plurality of holding units. The holding unit is configured to hold each of a plurality of samples having different shapes at a center position of the holding unit.

A sample holder according to another aspect of the present invention is used in a measurement apparatus configured to measure a sample. The sample holder includes: a substrate; and a holding unit configured to hold a sample. The substrate is provided with a plurality of holding units. The holding unit is configured to hold each of a plurality of samples having different shapes at a center position of the holding unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a schematic diagram showing the configuration of a sample holder according to the present embodiment.

FIG. 1B is a schematic diagram showing the configuration of the sample holder according to the present embodiment.

FIG. 2 is a schematic diagram showing the apparatus configuration of a measurement apparatus according to the present embodiment.

FIG. 3A is a schematic diagram showing a sample holder on which a tablet is placed.

FIG. 3B is a schematic diagram showing the sample holder on which a tablet is placed.

FIG. 4 is a flowchart for the measurement apparatus according to the present embodiment.

FIG. 5A is a schematic diagram for illustrating the distance between measurement points.

FIG. 5B is a schematic diagram for illustrating the distance between measurement points.

FIG. 5C is a schematic diagram for illustrating the distance between measurement points.

FIG. 5D is a schematic diagram for illustrating the distance between measurement points.

FIG. 6 is a schematic diagram showing a display example of measurement results.

FIG. 7 is a schematic diagram of an example showing different arrangement patterns of measurement points.

FIG. 8A is a schematic diagram showing a sample holder formed of a circular substrate.

FIG. 8B is a schematic diagram showing the sample holder formed of a circular substrate.

FIG. 9A is a schematic diagram showing a sample holder formed of a circular substrate.

FIG. 9B is a schematic diagram showing the sample holder formed of a circular substrate.

FIG. 10A is a schematic diagram showing a sample holder including a different number of holding units.

FIG. 10B is a schematic diagram showing the sample holder including a different number of holding units.

FIG. 10C is a schematic diagram showing a sample holder including a different number of holding units.

FIG. 10D is a schematic diagram showing the sample holder including a different number of holding units.

FIG. 10E is a schematic diagram showing a sample holder including a different number of holding units.

FIG. 10F is a schematic diagram showing the sample holder including a different number of holding units.

FIG. 11 is a schematic diagram of a sample holder including a holding unit configured to hold a sample by a movable pawl portion.

FIG. 12A is a schematic diagram of a sample holder including a holding unit configured to hold a sample with a plurality of holding pins.

FIG. 12B is a schematic diagram of the sample holder including the holding unit configured to hold a sample with a plurality of holding pins.

FIG. 13A is a schematic diagram of a holding unit configured to hold a sample with a holding pin.

FIG. 13B is a schematic diagram of a holding unit configured to hold a sample with a holding pin.

FIG. 13C is a schematic diagram of a holding unit configured to hold a sample with a holding pin.

FIG. 13D is a schematic diagram of a holding unit configured to hold a sample with a holding pin.

### DESCRIPTION OF THE PREFERRED EMBODIMENTS

The embodiments of the present invention will be hereinafter described in detail with reference to the accompanying drawings, in which the same or corresponding components are designated by the same reference characters, and description thereof will not be repeated.

<A. Sample Holder>

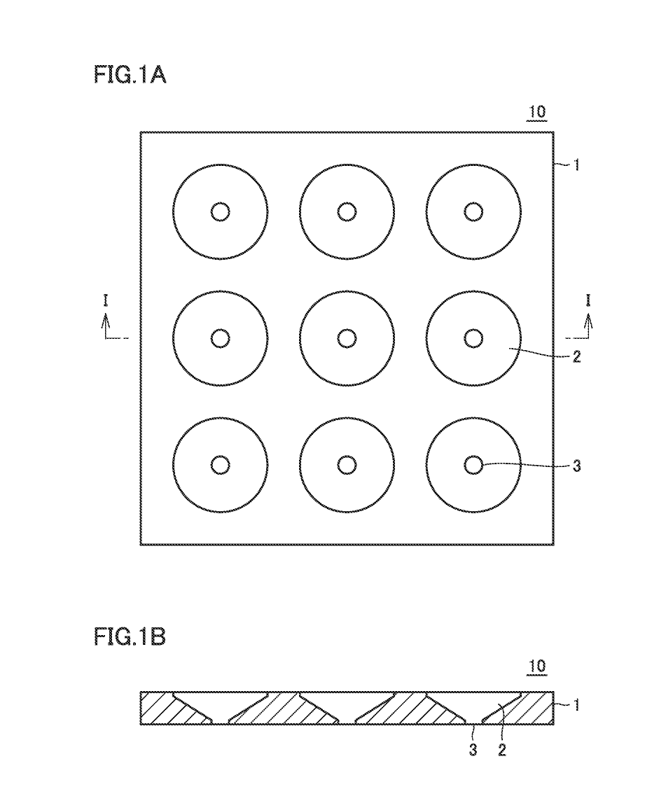

A measurement apparatus according to the present embodiment employs the structure capable of measuring a plurality of samples having different shapes (hereinafter also referred to as a sample) placed on a sample holder. FIGS. 1A and 1B each are a schematic diagram showing the configuration of a sample holder 10 according to the present embodiment. FIG. 1A is a plan view of sample holder 10. FIG. 1B is a cross-sectional view of sample holder 10 taken along an I-I plane. Sample holder 10 includes a substrate 1 and a holding unit 2 configured to hold a sample. Substrate 1 is provided with a plurality of holding units 2.

Substrate 1 is formed of a rectangular flat plate and made of aluminum, for example. Substrate 1 may be formed of other materials such as metal (stainless steel and the like) other than aluminum, resin materials (plastic and the like), and a glass material. Substrate 1 is provided with a total of nine holding units 2 including: three holding units arranged in the lateral direction in FIG. 1A; and three holding units arranged in the longitudinal direction in FIG. 1A. It is to be noted that the number and the size of holding unit 2 provided in substrate 1 are not limited to those shown in FIGS. 1A and 1B. Although a plurality of holding units 2 are arranged in a lattice shape on substrate 1, arrangement of holding units 2 is also not limited to those shown in FIGS. 1A and 1B. Sample holder 10 may be formed of a combination of a plurality of types of materials such as metal for substrate 1 and a resin material for the surface of holding unit 2 that comes into contact with a sample.

Holding unit 2 is formed as a recess portion having a truncated conical shape as shown in FIG. 1B and structured to hold a sample in the state where a part of the sample is in contact with the inside of the recess portion. In other words, holding unit 2 is formed in a grinding bowl shape so as to have a surface inclined from outside toward its center. Accordingly, various sizes and shapes of samples can be held by holding unit 2 since each of these various samples can partially come into contact with the inside of holding unit 2 at any one position. The inside shape of holding unit 2 is not limited to the shape having a surface continuously inclined from outside toward the center, but may be a shape inclined in a step-like pattern from outside toward the center. In other words, holding unit 2 may have an inner surface formed in a step-like pattern as long as holding unit 2 is entirely formed in a truncated conical shape. Furthermore, holding unit 2 does not need to be formed in a complete truncated conical shape, but may have an outer surface and a center portion that are formed perpendicular to the surface of substrate 1 for ease of processing and the like. Furthermore, the inclination of the surface of holding unit 2 from outside toward the center is not limited to the inclination shown in FIG. 1B.

Holding unit 2 has a center portion formed as a bottom (the underside of FIG. 1B) that has a hole 3 penetrating through sample holder 10. Hole 3 is formed in a circle that is concentric with the outer shape of holding unit 2. The shape of hole 3 is not limited to a circle but may be other shapes. Hole 3 provided in holding unit 2 prevents dust from accumulating on the bottom of holding unit 2. Thus, holding unit 2 exhibits excellent drainage also when sample holder 10 is washed with water.

Holding unit 2 does not need to have hole 3 at its bottom, but may have a recess portion having a truncated conical shape with a closed bottom. Furthermore, when holding unit 2 is not provided with hole 3 at its bottom, holding unit 2 does not have to have a flat bottom but may be formed as a recess portion having a conical shape.

Representative examples of the sample may be a tablet, a small-sized optical component such as a lens and a concave mirror, and the like. More specifically, a tablet may be formed in a circular shape, a triangular shape, a quadrangular shape, an elliptical shape, a rugby-ball shape, a hexagonal shape, an octagonal shape, and the like, and may be a hard capsule and the like.

<B. Measurement Apparatus>

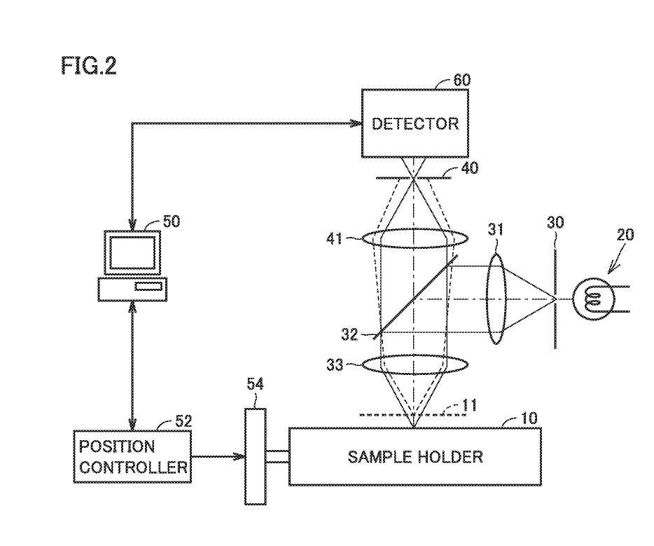

In the following description, a measurement apparatus configured to measure a sample placed on sample holder 10 is a confocal microscope, for example. FIG. 2 is a schematic diagram showing the apparatus configuration of a measurement apparatus 100 according to the present embodiment. As shown in FIG. 2, in measurement apparatus 100, light emitted from lamp 20 formed as a point light source by a pinhole 30 is applied to a sample placed on sample holder 10. In measurement apparatus 100, when pinhole 40 is located at the position that is optically conjugate with the focal plane (confocal plane), the light returned from the focal plane reaches a detector 60. The focal plane shown in FIG. 2 coincides with the surface of the sample placed on sample holder 10. Thus, the light returned from the sample reaches detector 60, but most of the light returned from a non-focal plane 11 and displaced from the surface of the sample does not reach detector 60 (the confocal effect). By means of this effect referred to as a confocal effect, measurement apparatus 100 as a confocal microscope can achieve a high-resolution and high-contrast microscopic image.

As a configuration for applying light emitted from lamp 20 onto a sample, measurement apparatus 100 includes a pinhole 30, a collimator lens 31, a beam splitter 32, and an objective lens 33. Furthermore, as a configuration for detecting the light from the sample, measurement apparatus 100 includes objective lens 33, beam splitter 32, a condenser lens 41, and pinhole 40.

Lamp 20 is a light source configured to emit light by it self, for example, and may be a laser that outputs light having a single wavelength, a light-emitting diode (LED) that outputs light having a wide wavelength width, an incandescent lamp, or the like. Furthermore, by using a laser that outputs light having a single wavelength as lamp 20, measurement apparatus 100 can be configured as a confocal laser scanning microscopy (CLS) that allows a fluorescent observation in a sample plane.

Detector 60 is an optical sensor capable of detecting the light such as ultraviolet light, visible light and infrared light from a sample, a spectrophotometer configured to output a wavelength spectrum contained in the light from a sample, or the like. More specifically, the optical sensor is formed of a photomultiplier tube, a photodiode, a charged coupled device (CCD) sensor, a complementary metal oxide semiconductor (CMOS) sensor, or the like. Furthermore, the spectrophotometer includes a diffraction grating for separating the incident light into wavelength components, and a detection element for detecting each of the wavelength components separated by the diffraction grating (a photomultiplier tube, a photodiode, a photodiode array, a CCD or the like).

In addition, lamp 20, pinholes 30 and 40, collimator lens 31, beam splitter 32, objective lens 33, condenser lens 41, and detector 60 constitute a measurement unit for measuring a sample placed on the sample holder.

By performing various kinds of numerical analysis processes (representatively, a fitting process and a noise removing process) based on the detection results (detected values, wavelength spectra, and the like) obtained from detector 60, an information processing apparatus 50 can identify the substance contained in the sample. Also, information processing apparatus 50 can calculate the size and the shape of the sample based on the position information of sample holder 10 obtained from a position controller 52.

Based on the control information from information processing apparatus 50, position controller 52 adjusts the position of sample holder 10 relative to objective lens 33, and outputs the position information of sample holder 10 to information processing apparatus 50. In other words, position controller 52 supplies a position instruction to a drive mechanism 54 based on the control information from information processing apparatus 50. Drive mechanism 54 can move sample holder 10 in the direction parallel to the surface on which the sample is placed and in the direction perpendicular to this parallel direction. Thus, drive mechanism 54 can move the measurement point on sample holder 10 for detector 60 and also can change the focal position (image formation position) of objective lens 33 relative to sample holder 10.

In measurement apparatus 100, information processing apparatus 50, position controller 52 and drive mechanism 54 constitute a control unit for controlling the position of the measurement unit relative to the sample to be measured.

Measurement apparatus 100 as a confocal microscope can measure various objects by using variously changed combinations of lamp 20 and detector 60. For example, when lamp 20 is used as a laser configured to output light having a single wavelength and measurement apparatus 100 is used as a confocal laser scanning microscope, the light from lamp 20 is scanned in the XYZ direction of the sample, so that the surface shape of the sample can be measured. Furthermore, when the sample having a fluorescent marker added thereto is measured, measurement apparatus 100 can measure distribution of the fluorescent marker in the sample.

Furthermore, when detector 60 is used as a spectrophotometer and measurement apparatus 100 is used as a confocal spectral reflectance measuring microscope, the spectral reflection spectrum only at the focal position can be measured, so that the spectral reflectance on the surface of the sample can be measured. Based on the detected reflection spectrum, the confocal spectral reflectance measuring microscope allows measurements such as calculation of the film thickness of the thin film sample applied onto the sample surface, identification of substance, and the like.

Furthermore, when lamp 20 is used as an infrared light source and detector 60 is used as a spectrophotometer allowing spectral detection of infrared light so as to be used as a confocal infrared spectrometric microscope, the light from lamp 20 is scanned in the XYZ direction of the sample to detect the infrared spectrum, so that the substance in the sample at each measurement point can be identified, thereby obtaining a distribution of the substance in the sample.

Furthermore, when detector 60 is used as a spectrophotometer and lamp 20 is configured to output light having a single wavelength by using a combination of a laser or a incandescent lamp that outputs light having a single wavelength and a spectroscope so as to be used as a confocal fluorescence spectrometric microscope, the fluorescence spectrum of the sample is measured to compare the measured fluorescence spectrum with the fluorescence spectrum specific to the substance, so that the substance contained in the sample can be identified.

Furthermore, when detector 60 is used as a spectrophotometer and lamp 20 is used as a laser configured to output light having a single wavelength so as to be used as a confocal laser Raman microscope, the Raman scattering light from the sample can be measured. The confocal laser Raman microscope is configured to compare the Raman spectrum of the sample with the Raman spectrum specific to the substance, so that the substance contained in the sample can be identified.

Measurement apparatus 100 is not limited to the confocal microscopes as described above but may be: a microspectroscopic apparatus configured to measure the spectral reflectance and the spectral transmittance of a sample using illumination light as a light source; a microscopic FTIR employing the Fourier conversion scheme (an infrared microscope); an FT Raman microscope; a three-dimensional (3D) shape measuring apparatus; a light interference microscope; a digital holographic microscope (DHM); and the like.

<C. Measuring Method>

The following is an explanation about a method of measuring a sample by measurement apparatus 100. In measurement apparatus 100, detector 60 can be switched between the optical sensor and the spectrophotometer. Also, in measurement apparatus 100, when lamp 20 is used as a laser configured to output light having a single wavelength, detector 60 is uses as an optical sensor to measure the shape of the sample by utilizing a confocal point, and detector 60 is also used as a spectrophotometer so as to be employed as a confocal laser Raman microscope, the component (substance) contained in the sample can be measured, which will be specifically described below.

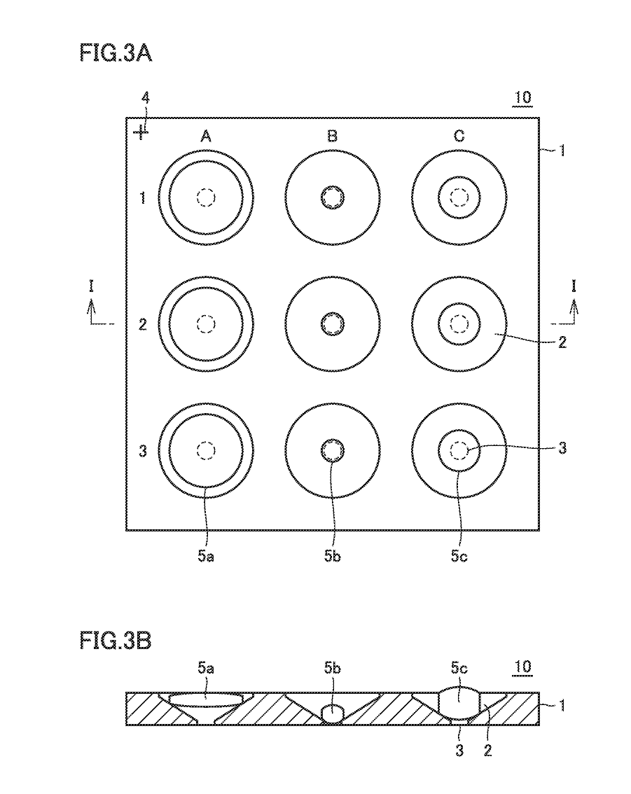

First, a tablet (sample) as an object to be measured is placed on sample holder 10. FIGS. 3A and 3B each are a schematic diagram showing sample holder 10 on which a tablet is placed. FIG. 3A shows a plan view of sample holder 10. FIG. 3B shows a cross-sectional view of sample holder 10 taken along an I-I plane.

In sample holder 10 shown in each of FIGS. 3A and 3B, an alignment mark 4 is provided on substrate 1. Thus, when sample holder 10 is placed on measurement apparatus 100 in the state where alignment mark 4 is located at the upper left in the figure, holding units 2 are arranged in the A column, the B column and the C column from the left, and also arranged in the first row, the second row and the third row from the top. In other words, holding unit 2 at the upper left in sample holder 10 can be identified as holding unit 2 at A1, and holding unit 2 in the center can be identified as holding unit 2 at B2. The alignment of the sample holder does not have to be set based on an alignment mark. For example, sample holder 10 may be aligned in the following manner. Specifically, sample holder 10 is placed such that a pin placed upright on the measurement apparatus at the position of the sample holder to be located is inserted into a hole provided at the position of alignment mark 4 on sample holder 10 (pin alignment).

In sample holder 10, for example, a tablet 5a having a diameter of 18 mm is held in holding unit 2 in the A column, a tablet 5b having a diameter of 5 mm is held in holding unit 2 in the B column, and a tablet 5c having a diameter of 10 mm is held in holding unit 2 in the C column. In other words, three types of different tablets 5a to 5c can be placed on sample holder 10. Accordingly, by using the above-mentioned sample holder 10 in measurement apparatus 100, measurement apparatus 100 can measure three types of different tablets without having to perform the operations of holding/removing a sample.

Furthermore, sample holder 10 includes holding unit 2 formed in a truncated conical shape. Accordingly, even when tablets 5a to 5c have different diameters, each of these tablets 5a to 5c can partially come into contact with the inside of a corresponding one of holding units 2 at any position, so that tablets 5a to 5c can be reliably held in holding units 2. As shown in FIG. 3B, tablet 5a having a larger diameter is held in contact with holding unit 2 at a position farther away from the center position of holding unit 2 while tablet 5b having a smaller diameter is held in contact with holding unit 2 at a position closer to the center position of holding unit 2. Tablet 5c that is larger in diameter than tablet 5b is held in contact with holding unit 2 at a position farther away from the center position of holding unit 2 as compared with tablet 5b.

Also as shown in FIG. 3A, the center position of holding unit 2 (the vertex of the truncated cone) coincides with the center position of each of tablets 5a to 5c held in a corresponding one of holding units 2. Specifically, even when tablet 5a has a larger diameter and tablet 5b has a smaller diameter, the center position of holding unit 2 similarly coincides with the center position of each of tablets 5a and 5b held in their respective holding units 2. Thus, without having to measure and calculate the center position of each tablet, measurement apparatus 100 can set the predetermined center position of each holding unit 2 as the center position of the tablet held in each holding unit 2. By setting sample holder 10 in the state where alignment mark 4 is positioned in alignment, measurement apparatus 100 can measure the center position of holding unit 2 as the center position of each of tablets 5a to 5c, so that the position of each tablet can be readily aligned.

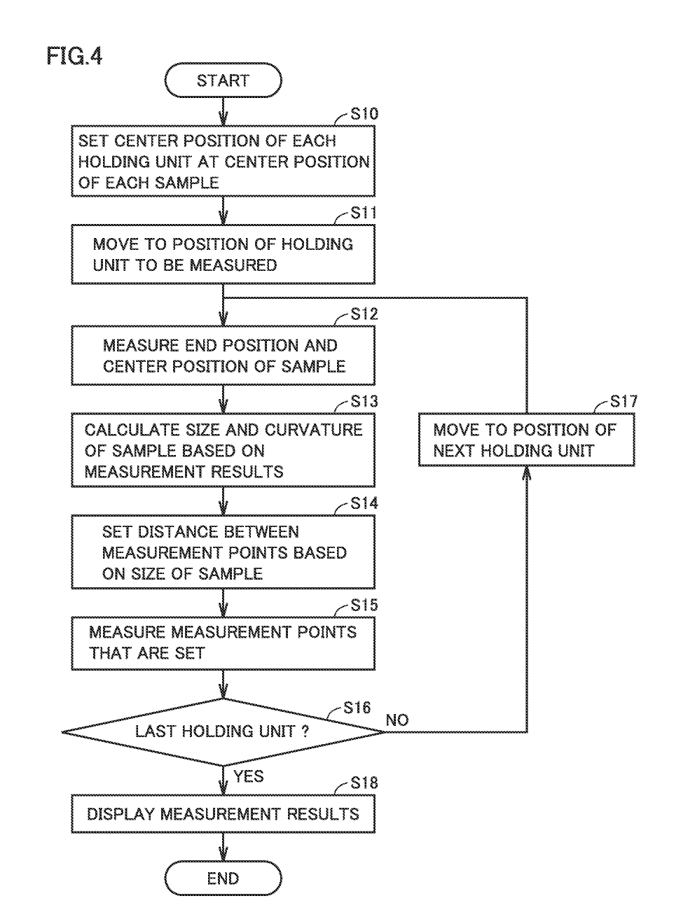

The following is an explanation about the flowchart in the case where the sample placed on sample holder 10 is measured with measurement apparatus 100. FIG. 4 is a flowchart for measurement apparatus 100 according to the present embodiment. The flowchart shown in FIG. 4 will be described below with reference to an example of the configuration in which tablets 5a to 5c are placed on sample holder 10 shown in each of FIGS. 3A and 3B. Furthermore, in measurement apparatus 100, information processing apparatus 50 (see FIG. 2) controls the position of the measurement unit relative to tablets 5a to 5c to be measured; calculates the result detected by detector 60; and the like, which will be described below.

First, when sample holder 10 is placed on measurement apparatus 100 in the state where alignment mark 4 is positioned in alignment, information processing apparatus 50 sets the center position of each holding unit 2 at the center position of each of tablets 5a to 5c (step S10).

Then, based on the center position of each of tablets 5a to 5c set in step S10, information processing apparatus 50 moves the measurement unit to the position of holding unit 2 to be measured (step S11). When holding unit 2 at A1 on sample holder 10 shown in each of FIGS. 3A and 3B is first measured, information processing apparatus 50 moves the measurement unit to the center position of holding unit 2 at A1. In the above explanation, information processing apparatus 50 moves the measurement unit to sample holder 10, but information processing apparatus 50 may move sample holder 10 to the measurement unit.

Then, information processing apparatus 50 measures the end position of tablet 5a and the center position of tablet 5a (step S12). Specifically, in order to measure the shape of tablet 5a, information processing apparatus 50 measures the coordinates (x₁, y₁, z₁) at the end position of tablet 5a and the coordinate (z₂) at the center position of tablet 5a. The measured coordinates x and y each indicate the position in the plane of sample holder 10 while the measured coordinate z indicates the height of the sample in the direction perpendicular to the surface of sample holder 10. Furthermore, the x and y coordinates at the center position of tablet 5a are not measured since these coordinates are previously set in step S10.

Then, information processing apparatus 50 calculates the size and the curvature of tablet 5a (sample) based on the measurement results obtained in step S12 (step S13). Specifically, based on the coordinates at the center position of tablet 5a set in step S10 and the measured coordinates (x₁, y₁) at the end position of tablet 5a, information processing apparatus 50 can calculate the size (diameter) of tablet 5a. Furthermore, information processing apparatus 50 calculates the curvature of tablet 5a based on the height (z₂) in the center position of tablet 5a and the height (z₁) in the end position of tablet 5a.

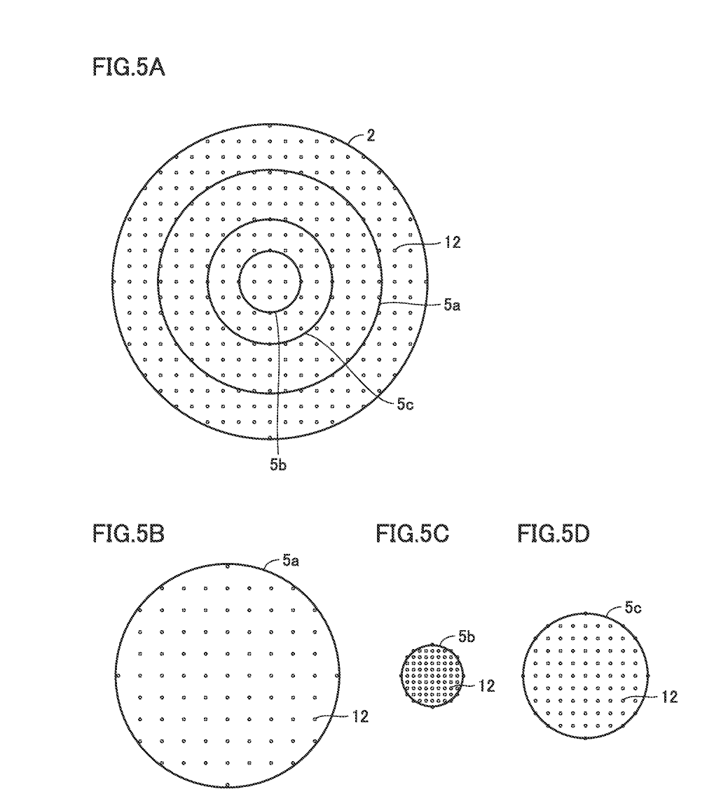

Then, information processing apparatus 50 sets the distance between the measurement points based on the size of tablet 5a (sample) calculated in step S13 (step S14). Measurement apparatus 100 can set a plurality of measurement points for one sample and measure, for example, the Raman scattering light for each measurement point to thereby identify the substance. The measurement points can be arranged at a fixed distance form each other irrespective of the size of the sample, and also arranged at a distance from each other such that each sample includes the same number of measurement points irrespective of the size of the sample. FIGS. 5A to 5D each show a schematic diagram for specifically illustrating the distance between the measurement points. FIG. 5A is a diagram showing the measurement points arranged at a fixed distance from each other irrespective of the size of the sample. FIGS. 5B to 5D each are a diagram showing the measurement points arranged at a distance from each other such that each sample includes the same number of measurement points irrespective of the size of the sample.

In holding unit 2 shown in FIG. 5A, measurement points 12 are arranged at regular intervals. Accordingly, the number of measurement points 12 at which each tablet is measured is different among the cases where: tablet 5a is held; tablet 5b is held; and tablet 5c is held. In other words, measurement apparatus 100 can obtain the measurement results from more measurement points 12 in the case of larger tablet 5a, but can obtain the measurement results only from less measurement points 12 in the case of smaller tablet 5b. However, since each measurement distance is fixed, the control for moving the measurement unit can be readily done.

On the other hand, the same number of measurement points 12 are included in each of tablet 5a shown in FIG. 5B, tablet 5b shown in FIG. 5C, and tablet 5c shown in FIG. 5D. Thus, measurement apparatus 100 obtains the measurement results from the same number of measurement points 12 irrespective of the size of the each tablet. However, since the measurement distance is different depending on the size of each tablet, the control for moving the measurement unit becomes complicated.

Then, information processing apparatus 50 measures measurement points 12 set in step S14 (step S15). Specifically, information processing apparatus 50 moves the measurement unit to the previously-set measurement point 12 and measures, for example, the Raman scattering light from each measurement point 12 with detector 60 to obtain the results.

When the measurement of tablet 5a held in holding unit 2 at A1 on sample holder 10 ends, measurement apparatus 100 measures tablet 5a held in next holding unit 2 at A2. Thus, information processing apparatus 50 moves the measurement unit located in holding unit 2 at A1 to the position of holding unit 2 at A2. Information processing apparatus 50 determines whether or not the current holding unit 2 is the last holding unit 2 to be measured (step S16). In sample holder 10 shown in each of FIGS. 3A and 3B, holding unit 2 at C3 is assumed to be the last holding unit 2.

When it is determined that the current holding unit 2 is not the last holding unit 2 (NO in step S16), information processing apparatus 50 moves the measurement unit to the position of the next holding unit 2 (step S17). When it is determined that the current holding unit 2 is the last holding unit 2 (holding unit 2 at C3) (YES in step S16), information processing apparatus 50 displays the measurement results on a monitor connected thereto (step S18).

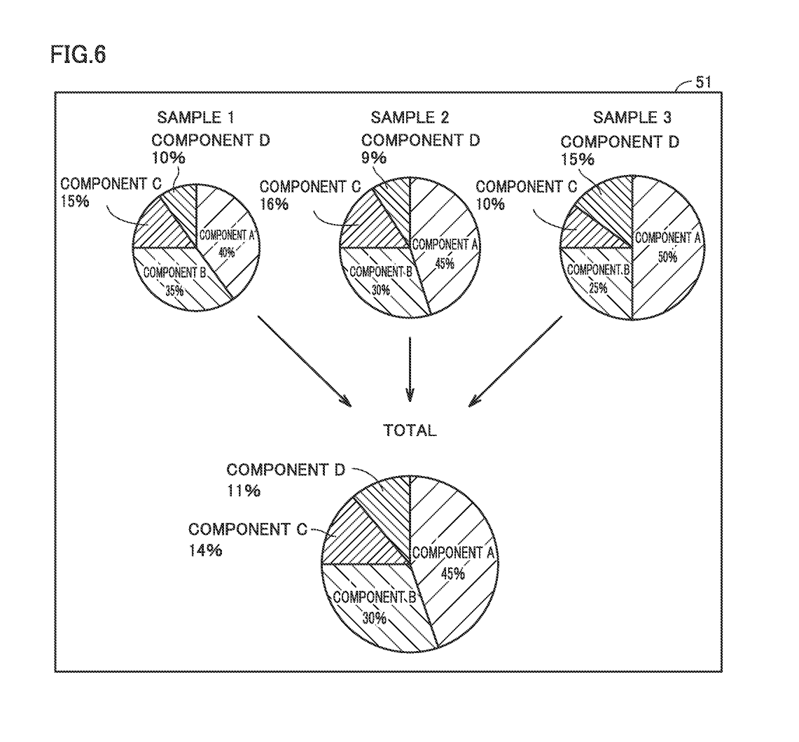

FIG. 6 is a schematic diagram showing a display example of the measurement results. Display screen 5l shown in FIG. 6 shows sample 1 exhibiting the component ratio of tablet 5a held in holding unit 2 at A1. Specifically, tablet 5a placed at A1 contains 40% of component A, 35% of component B, 15% of component C, and 10% of component D. Similarly, display screen 5l shown in FIG. 6 shows sample 2 exhibiting the component ratio of tablet 5a held in holding unit 2 at A2, and sample 3 exhibiting the component ratio of tablet 5a held in holding unit 2 at A3. Specifically, tablet 5a placed at A2 contains 45% of component A, 30% of component B, 16% of component C, and 9% of component D. Tablet 5a placed at A3 contains 50% of component A, 25% of component B, 10% of component C, and 15% of component D. FIG. 6 further shows the total component ratio obtained by summing the component ratios of sample 1 to sample 3. Tablet 5a contains the average component including: 45% of component A, 30% of component B, 14% of component C, and 11% of component D. In this way, sample holder 10 can hold a plurality of tablets (samples). Thus, measurement apparatus 100 can measure the same type of samples several times in one sample placement. Accordingly, measurement apparatus 100 can performs a statistical process for component variations and the like based on the plurality of measurement results obtained from the same type of samples.

As described above, measurement apparatus 100 according to the present embodiment includes: a sample holder 10 on which a plurality of samples can be placed; a measurement unit configured to measure the plurality of samples placed on sample holder 10; and a control unit configured to control the position of the measurement unit relative to the sample to be measured. Furthermore, sample holder 10 includes a substrate 1 and a holding unit 2 configured to hold the sample. Substrate 10 is provided with a plurality of holding units 2. Holding unit 2 is configured to be capable of holding each of the plurality of samples having different shapes at the center position of holding unit 2. By providing such a configuration, when measurement apparatus 100 measures a plurality of samples using sample holder 10 on which a plurality of samples having different shapes can be placed, the operations of holding and removing each sample can be reduced.

Particularly, in sample holder 10 according to the present embodiment, holding unit 2 is formed as a recess portion having a conical shape or a truncated conical shape, and structured to hold a sample in the state where a part of the sample is in contact with the inside of the recess portion, so that holding unit 2 can hold each of a plurality of samples having different shapes at its center position. By providing such a configuration, even when a plurality of samples having different shapes are placed on holding units 2 each having a conical shape or a truncated conical shape, the plurality of samples can be held at the center positions of their respective holding units 2.

Furthermore, the control unit may control the position of the measurement unit relative to the sample with respect to the center position of holding unit 2 as the center position of the sample held in holding unit 2. By providing such a configuration, measurement apparatus 100 does not have to calculate the center position of the sample by measurement, so that the position of the held sample can be readily aligned.

Furthermore, the control unit can calculate the size of the sample based on at least one sample end position measured by the measurement unit and the center position of the holding unit. Since the center position of the holding unit coincides with the center position of the sample, measurement apparatus 100 can calculate the size of the sample only by measuring the position of the sample end.

Furthermore, the control unit can set the number of measurement points, at which the sample is measured, based on the calculated size of the sample (i) such that each sample includes the same number of measurement points irrespective of the size of the sample, or (ii) such that the measurement points are arranged at a fixed distance from each other irrespective of the size of the sample. Measurement apparatus 100 can change the distance between the measurement points according to the sample.

Furthermore, the measurement unit can optically measure the sample to measure the height of the sample in the direction perpendicular to sample holder 10. For example, the measurement unit can measure the height of the sample utilizing a confocal point by means of a lamp used as a white light source.

Furthermore, the control unit can calculate the curvature of the sample based on (i) the height of the sample in at least one sample end position measured by the measurement unit and (ii) the height of the sample in the center position of the holding unit. For example, information processing apparatus 50 calculates the curvature of tablet 5a based on the height (z₂) in the center position of tablet 5a and the height (z₁) in the end position of tablet 5a.

Furthermore, holding unit 2 has a hole 3 provided in a part of the recess portion and penetrating through sample holder 10. Such a configuration can prevent dust from accumulating on the bottom of holding unit 2. Thus, holding unit 2 exhibits excellent drainage also when sample holder 10 is washed with water.

<D. Modification>

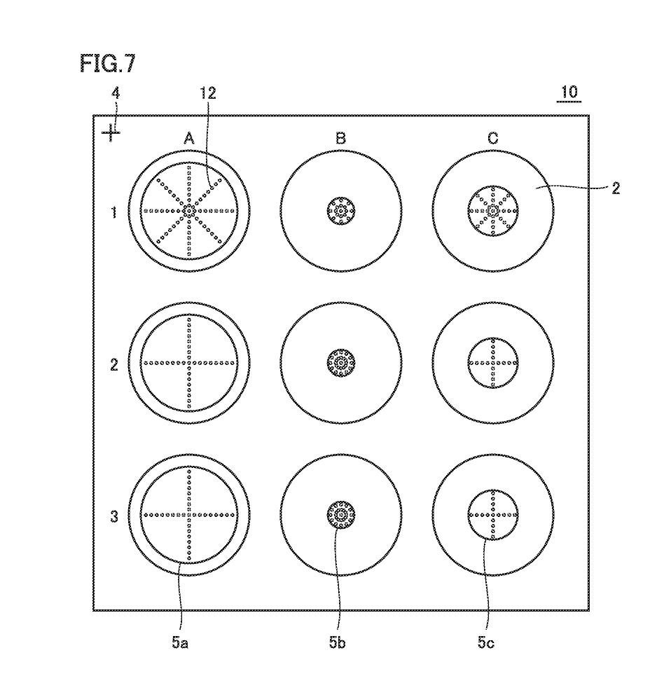

(1) Measurement apparatus 100 according to the present embodiment has been described with reference to an example of the arrangement pattern in which the measurement points are arranged at regular intervals as shown in FIGS. 5A to 5D. However, the arrangement pattern of the measurement points is not limited to the above, but another arrangement pattern may be employed or different arrangement patterns may be employed for each holding unit 2. FIG. 7 is a schematic diagram of an example showing different arrangement patterns of measurement points 12. As in sample holder 10 shown in each of FIGS. 3A and 3B, in sample holder 10 shown in FIG. 7, when sample holder 10 is set in measurement apparatus 100 in the state where alignment mark 4 is located at the upper left in the figure, holding units 2 are arranged in the A column, the B column and the C column from the left and also arranged in the first row, the second row and the third row from the top. In other words, holding unit 2 at the upper left in sample holder 10 is identified as holding unit at A1, and holding unit 2 in the center is identified as holding unit 2 at B2. Also in sample holder 10 shown in FIG. 7, for example, tablet 5a having a diameter of 18 mm is held in holding unit 2 in the A column, tablet 5b having a diameter of 5 mm is held in holding unit 2 in the B column, and tablet 5c having a diameter of 10 mm is held in holding unit 2 in the C column.

As shown in FIG. 7, measurement apparatus 100 sets the arrangement pattern of measurement points 12 so as to be arranged radially on the tablet in the first row, and sets the arrangement pattern of measurement points 12 so as to be arranged in a cross shape on the tablet in the A column in each of the second and third rows, and on the tablet in the C column in each of the second and third rows. Also, measurement apparatus 100 sets the arrangement pattern of measurement points 12 so as to be arranged in a concentric manner on the tablet in the B column in each of the second and third rows.

In this way, for each holding unit 2, the control unit can change the arrangement pattern of measurement points 12 at which the sample is measured. By providing such a configuration, measurement apparatus 100 can conduct a measurement in accordance with the sample characteristics such as the shape of the sample.

(2) Measurement apparatus 100 according to the present embodiment has been described with reference to an example of sample holder 10 formed of substrate 1 having a rectangular shape as shown in FIGS. 1A and 1B. However, the shape of the sample holder is not limited to a rectangular shape, but the sample holder may be formed of a substrate having another shape. For example, the sample holder formed of a circular substrate will be hereinafter described.

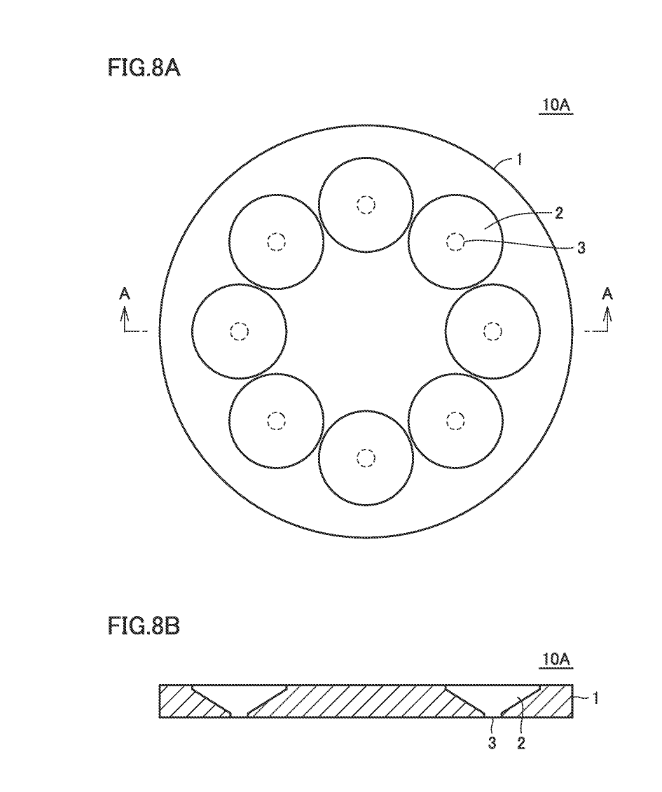

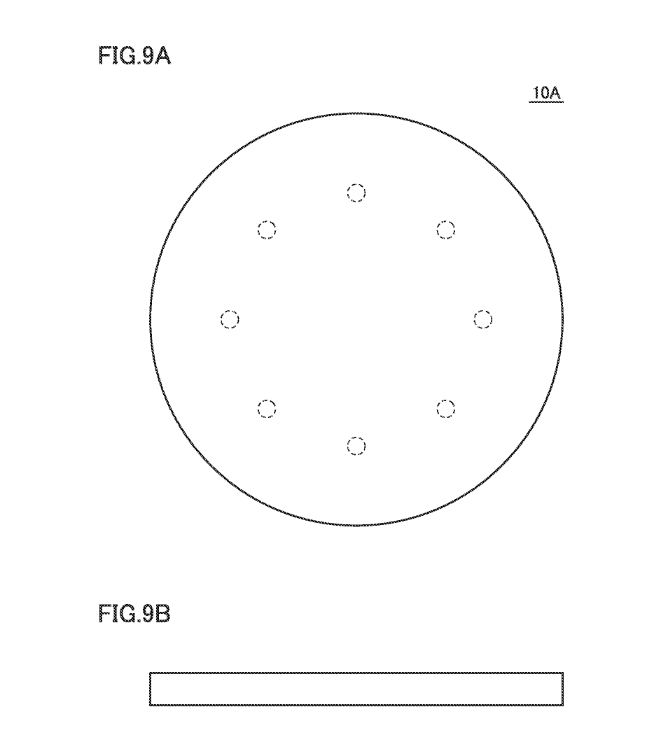

FIGS. 8A, 8B, 9A, and 9B each are a schematic diagram of a sample holder 10A formed of a circular substrate. FIG. 8A is a plan view of sample holder 10A. FIG. 8B is a cross-sectional view of sample holder 10A taken along an A-A plane. FIG. 9A is a bottom view of sample holder 10A. FIG. 9B is a front view of sample holder 10A. The left side view, the right side view and the rear view of sample holder 10A each are the same as the front view shown in FIG. 9B, and therefore, not shown. In sample holder 10A shown in each of FIGS. 8A, 8B, 9A, and 9B, the outline of each characterizing portion for design is drawn with a solid line, and the outline of each non-characterizing portion is drawn with a dashed line.

Sample holder 10A includes circular flat plate-shaped substrate 1 provided with a plurality of holding units 2. Substrate 1 is not provided with a plurality of holding units 2 arranged in a lattice shape as shown in FIGS. 1A and 1B but provided with eight holding units 2 arranged in a circumferential shape. Holding units 2 may be arranged to form two or three concentric circumferences as long as sample holder 10A has enough diameter. Furthermore, holding units 2 may be arranged to form a swirl shape.

When sample holder 10A is rotatably fixed at the center of substrate 1, measurement apparatus 100 can rotate sample holder 10A to move the sample to be measured toward the measurement range.

In sample holder 10A shown in each of FIGS. 8A, 8B, 9A, and 9B, the outline of each characterizing portion for design is drawn with a solid line while the outline of each non-characterizing portion is drawn with a dashed line. When the present application is changed to the application for design registration, the partial design of the portion shown by a solid line in each of the figures can be specified as the “design for which registration is requested”. Also, an optional design portion in the region surrounded by the outline drawn with a dashed line, and the design portion including a combination of the optional portion and the portion surrounded by the outline drawn with a solid line can be specified as the “design for which registration is requested”. Furthermore, the design of the entire shape of sample holder 10A may be changed to the application for design registration as the “design for which registration is requested”. In other words, FIGS. 8A, 8B, 9A, and 9B show designs in every manner that can be specified in each of the figures.

(3) Measurement apparatus 100 according to the present embodiment has been described with reference to an example of sample holder 10 including rectangular substrate 1 provided with nine holding units 2 as shown in FIGS. 1A and 1B. However, the number of holding units 2 provided in the sample holder is not limited to nine but another number of holding units 2 may be provided in the substrate.

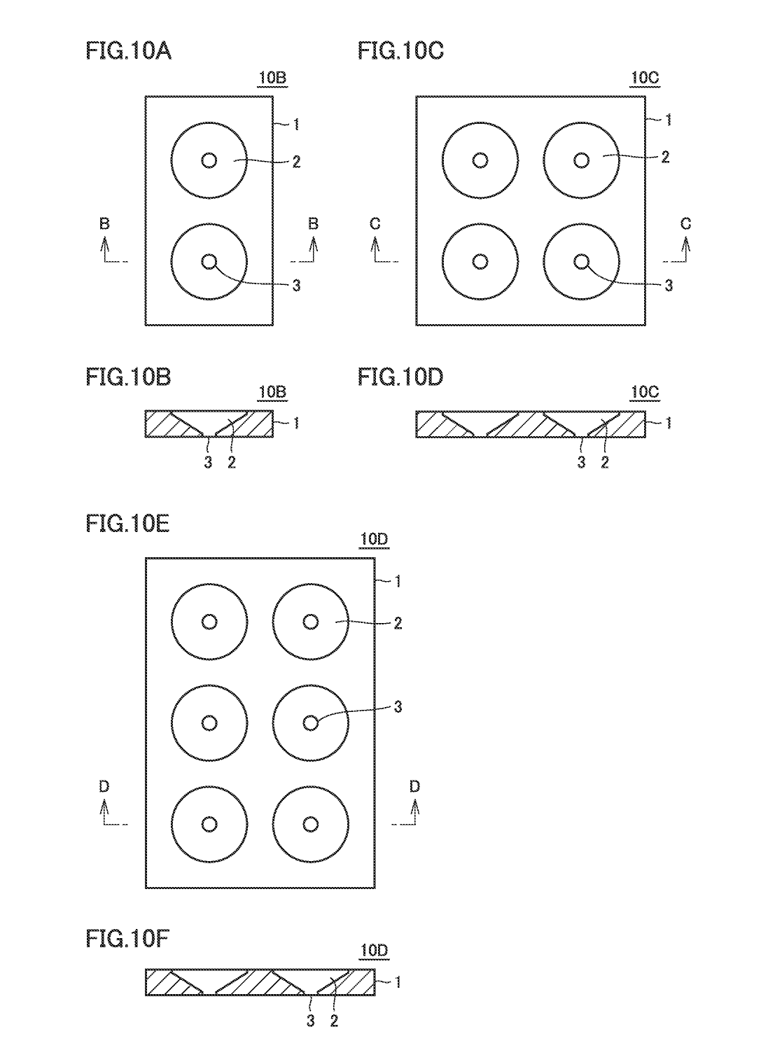

FIGS. 10A to 10F are schematic diagrams of sample holders that are different in number of holding units 2. FIG. 10A shows a sample holder 10B including rectangular substrate 1 provided with two holding units 2. FIG. 10B is a cross-sectional view of sample holder 10B taken along a B-B plane. FIG. 10C shows a sample holder 10C including rectangular substrate 1 provided with four holding units 2. FIG. 10D is a cross-sectional view of sample holder 10C taken along a C-C plane. FIG. 10E shows a sample holder 10D including rectangular substrate 1 provided with six holding units 2. FIG. 10F is a cross-sectional view of sample holder 10D taken along a D-D plane.

(4) Measurement apparatus 100 according to the present embodiment has been described with reference to an example of sample holder 10 including holding unit 2 that is formed as a recess portion having a conical shape or a truncated conical shape as shown in FIGS. 1A and 1B so as to hold a sample in the state where a part of the sample is in contact with the inside of the recess portion. However, holding unit 2 formed in the sample holder may have any configuration as long as holding unit 2 can hold each of a plurality of samples having different shapes at the center position of holding unit 2. In other words, the configuration of the holding unit is not limited to a recess portion having a conical shape or a truncated conical shape, but the holding unit may have another configuration as long as the holding unit is configured to be capable of holding each of samples having various different shapes.

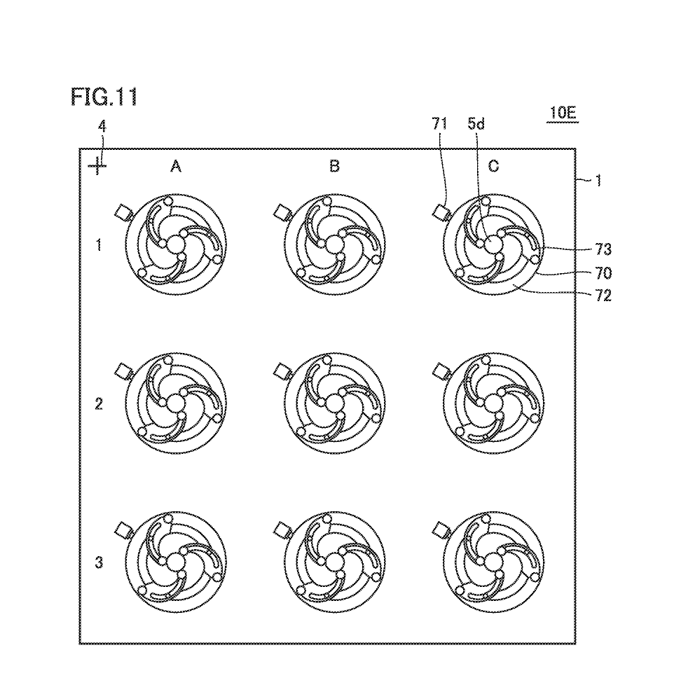

For example, the holding unit may be configured to hold each of the plurality of samples having different shapes at the center position of the holding unit by holding each of the plurality of samples with a plurality of pawl portions (movable members) provided in the substrate. FIG. 11 is a schematic diagram of a sample holder having a holding unit configured to hold a sample with a movable pawl portion. As in sample holder 10 shown in each of FIGS. 3A and 3B, in sample holder 10E shown in FIG. 11, when sample holder 10E is set in measurement apparatus 100 in the state where alignment mark 4 is located at the upper left in the figure, holding units 70 are arranged in the A column, the B column and the C column from the left and also arranged in the first row, the second row and the third row from the top.

Holding unit 70 shown in FIG. 11 holds a tablet 5d (sample) while three pawl portions 73 attached to a frame 72 provided in substrate 1 are moved by an adjustment screw 71. In other words, holding unit 70 holds tablet 5d at three points using three pawl portions 73. Also, three pawl portions 73 can be moved by operating adjustment screw 71 to change the distance among three pawl portions 73 according to the size of the sample to be held. In addition, holding unit 70 is designed such that the center position of the sample is always located at the center position of the same holding unit when the sample is held by three pawl portions 73.

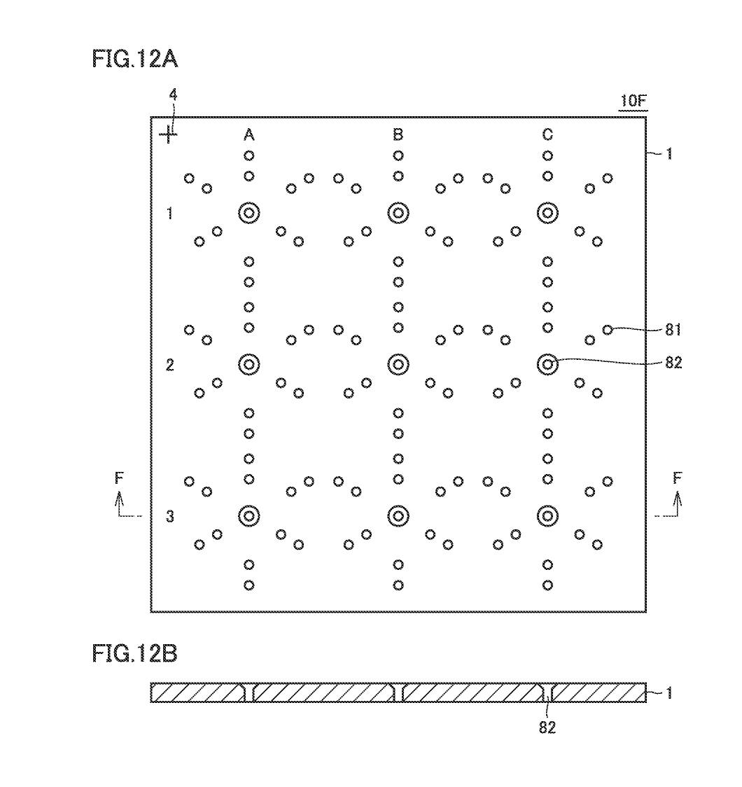

(5) The holding unit may be configured to be capable of holding each of a plurality of samples having different shapes at the center position of the holding unit by holding each of the plurality of samples using a plurality of holding pins, each of the plurality of holding pins being inserted into a hole provided in the substrate for fixation. FIGS. 12A and 12B each are a schematic diagram of a sample holder having a holding unit configured to hold a sample with a plurality of holding pins. FIG. 12A is a plan view of a sample holder 10F. FIG. 12B is a cross-sectional view of sample holder 10F taken along an F-F plane. As in sample holder 10 shown in each of FIGS. 3A and 3B, in sample holder 10F shown in each of FIGS. 12A and 12B, when sample holder 10F is set in measurement apparatus 100 in the state where alignment mark 4 is located at the upper left in the figure, the holding units are arranged in the A column, the B column and the C column from the left and also arranged in the first row, the second row and the third row from the top. Each of the holding units shown in FIGS. 12A and 12B is provided with a through hole 82 at the position of substrate 1 corresponding to the center position of each holding unit, and also provided with holes 81 at regular intervals around through hole 82. Each of the holding pins is inserted through a corresponding one of holes 81 so as to be placed upright.

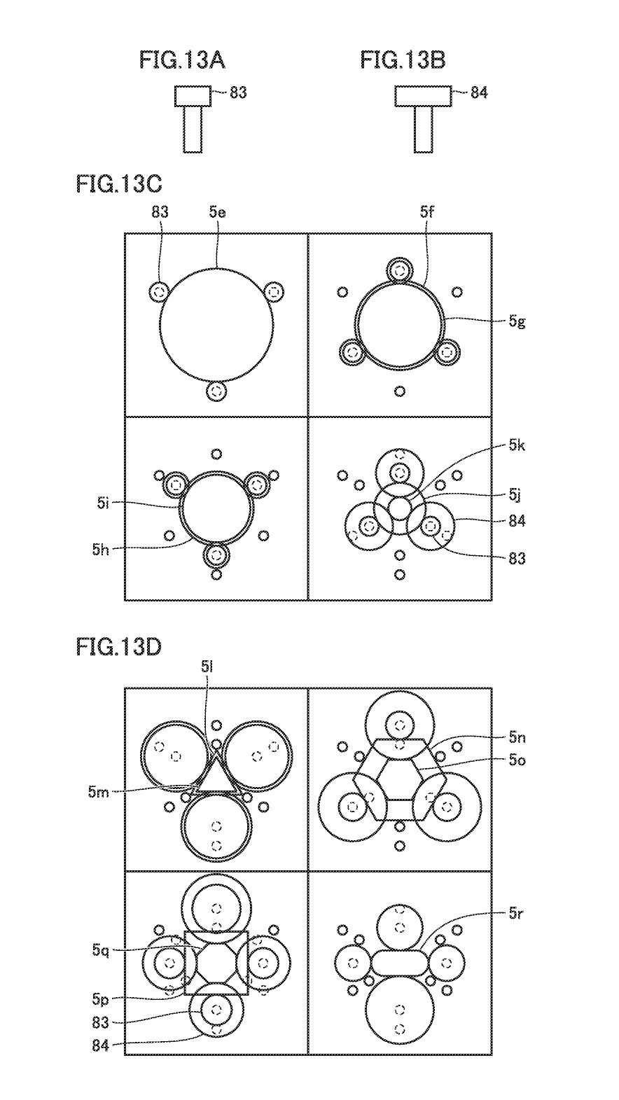

The following is a specific explanation about the configuration for holding a sample with a plurality of holding pins. FIGS. 13A to 13D each are a schematic diagram of a holding unit configured to hold a sample with holding pins. FIGS. 13A and 13B show holding pins 83 and 84, respectively, inserted through holes 81 so as to be placed upright. Holding pin 84 is designed such that a portion for holding a sample (a head portion) is larger in diameter than holding pin 83. In FIG. 13C, a tablet 5e is held with three holding pins 83. In other words, the holding unit holds tablet 5e at three points using three holding pins 83. The holding unit can hold each of samples having various shapes by using at least three holding pins. FIG. 13C shows the manner in which each of the holding units holds a corresponding one of tablets 5f to 5i having different diameters by using holding pins having head portions with different diameters even when each of these holding pins having head portions with different diameters is inserted through the same hole 81. Specifically, the holding unit holds a tablet 5j using holding pin 83 and holds a tablet 5k smaller in diameter than tablet 5j using holding pin 84 having a head portion larger in diameter than holding pin 83.

The shape that can be held by the holding unit is not limited to a circular shape, but may be a triangular shape, a quadrangular shape, a hexagonal shape, an octagonal shape, an elliptical shape, and the like. FIG. 13D shows the manner in which the holding unit uses three holding pins to hold each of triangular tablets 5l and 5m and hexagonal tablets 5n and 5o, and also uses four holding pins to hold each of a quadrangular tablet 5p, an octagonal tablet 5q and an elliptical tablet 5r. Specifically, the holding unit uses four holding pins 83 to hold quadrangular tablet 5p, and uses four holding pins 84 each having a head portion larger in diameter than holding pin 83 to hold octagonal tablet 5q.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A measurement apparatus configured to measure a sample, the measurement apparatus comprising:
a sample holder on which a plurality of samples can be placed;
a measurement unit configured to measure the plurality of samples placed on the sample holder; and
a control unit configured to control a position of the measurement unit relative to a sample to be measured,
the sample holder including
a substrate, and
a holding unit configured to hold a sample,
the substrate being provided with a plurality of holding units,
the holding unit being configured to hold each of a plurality of samples having different shapes at a center position of the holding unit.

2. The measurement apparatus according to claim 1, wherein
the holding unit is formed as a recess portion having a conical shape or a truncated conical shape, and
the holding unit is configured to hold each of the plurality of samples having different shapes at the center position of the holding unit by holding each of the plurality of samples in a state where each of the plurality of samples is partially in contact with an inside of the recess portion.

3. The measurement apparatus according to claim 1, wherein the holding unit is configured to hold each of the plurality of samples having different shapes at the center position of the holding unit by holding each of the plurality of samples using a plurality of pins, each of the plurality of pins being inserted into a hole provided in the substrate for fixation.

4. The measurement apparatus according to claim 1, wherein the holding unit is configured to hold each of the plurality of samples having different shapes at the center position of the holding unit by holding each of the plurality of samples using a plurality of movable members provided in the substrate.

5. The measurement apparatus according to claim 1, wherein the control unit is configured to control the position of the measurement unit relative to the sample with respect to the center position of the holding unit as a center position of the sample held in the holding unit.

6. The measurement apparatus according to claim 2, wherein the control unit is configured to calculate a size of the sample based on at least one sample end position measured by the measurement unit and the center position of the holding unit.

7. The measurement apparatus according to claim 6, wherein
the control unit is configured to set a distance between measurement points based on the calculated size of the sample such that each sample includes measurement points equal in number irrespective of the size of the sample, and
the sample is measured at each of the measurement points.

8. The measurement apparatus according to claim 6, wherein
the control unit is configured to set how many measurement points are provided, based on the calculated size of the sample, such that the measurement points are arranged at a fixed distance from each other irrespective of the size of the sample, and
the sample is measured at each of the measurement points.

9. The measurement apparatus according to claim 2, wherein the control unit is capable of changing, for each of the plurality of holding units, an arrangement pattern of measurement points at which the sample is measured.

10. The measurement apparatus according to claim 2, wherein the measurement unit is capable of optically measuring the sample to measure a height of the sample in a direction perpendicular to the sample holder.

11. The measurement apparatus according to claim 10, wherein the control unit is configured to calculate a curvature of the sample based on (i) the height of the sample in at least one sample end position measured by the measurement unit, and (ii) the height of the sample in the center position of the holding unit.

12. The measurement apparatus according to claim 2, wherein the holding unit has a hole provided in a part of the recess portion and penetrating through the sample holder.

13. A sample holder used in a measurement apparatus configured to measure a sample, the sample holder comprising:
a substrate; and
a holding unit configured to hold a sample,
the substrate being provided with a plurality of holding units,
the holding unit being configured to hold each of a plurality of samples having different shapes at a center position of the holding unit.

14. The sample holder according to claim 13, wherein
the holding unit is formed as a recess portion having a conical shape or a truncated conical shape, and
the holding unit is configured to hold each of the plurality of samples having different shapes at the center position of the holding unit by holding each of the plurality of samples in a state where each of the plurality of samples is partially in contact with an inside of the recess portion.

15. The sample holder according to claim 13, wherein the holding unit is configured to hold each of the plurality of samples having different shapes at the center position of the holding unit by holding each of the plurality of samples using a plurality of pins, each of the plurality of pins being inserted into a hole provided in the substrate for fixation.

16. The sample holder according to claim 13, wherein the holding unit is configured to hold each of the plurality of samples having different shapes at the center position of the holding unit by holding each of the plurality of samples using a plurality of movable members provided in the substrate.

17. The sample holder according to claim 14, wherein the holding unit has a hole provided in a part of the recess portion and penetrating through the sample holder.
